(19) United States
(12) Patent Application Publication
(10) Pub. No.: US 2014/0084502 A1
(43) Pub. Date: Mar. 27, 2014

(54) METHOD FOR PRODUCING WAFER LENS, DEVICE FOR PRODUCING WAFER LENS, AND METHOD FOR PRODUCING OPTICAL ELEMENT

(71) Applicants: Susumu Kojima, Hachioji-shi (JP); Nobuhiro Saruya, Hino-shi (JP)

(72) Inventors: Susumu Kojima, Hachioji-shi (JP); Nobuhiro Saruya, Hino-shi (JP)

(73) Assignee: KONICA MINOLTA, INC., TOKYO (JP)

(21) Appl. No.: 14/118,822

(22) PCT Filed: May 23, 2012
(86) PCT No.: PCT/JP2012/063191

§ 371 Date: Nov. 19, 2013

(30) Foreign Application Priority Data
May 26, 2011 (JP) 2011-118320

(51) Int. Cl. B29D 11/00

(52) U.S. Cl. CPC B29D 11/00932
USPC 264/2.7; 264/1.1; 425/110

(57) ABSTRACT

A purpose is to provide a method for producing a wafer lens and a device, capable of forming a wafer lens provided with a plurality of optical elements having intended properties. In order to adjust the gap between a molding die 91 and a transparent substrate 95, a positioning device 50 provided independently of the molding die 91 is used, and thus provision of a gap-adjusting projection in the molding die 91 becomes unnecessary and the thickness of an optical element 15 based on an optical surface Pd can be set regardless of the thickness of the transparent substrate 95. Consequently, there can be formed a wafer lens WL provided with a plurality of optical elements 15 having intended properties.

### TECHNICAL FIELD

The present invention relates to a method for producing a wafer lens for forming a plurality of optical lenses made of resin by transfer onto a substrate having light transmittivity, a device for producing a wafer lens, and an optical element obtained by these.

### BACKGROUND ART

In recent years, for the purpose of cost reduction by the improvement of mass productivity, there has been known one used as a lens for an image pickup device or the like, which is obtained by making what we call a wafer lens having a plurality of optical element parts formed on a surface of a base member having light transmittivity and, after that, by cutting, into pieces, individual optical element parts with the base member.

In making such a wafer lens, as a die having a transfer surface for forming or molding a plurality of optical element parts, the die in which there is integrally formed a projection for defining a gap from the base member surface on which the optical element part is to be formed, to the optical element part surface, is known (for example, see Patent Literatures 1 and 2).

The optical system constituted of the lens cut and separated from the wafer lens as described above is extremely small, as represented by a camera module for a mobile phone. A lens that is to be incorporated in such an optical system is effective for simplifying a production process if assembling can be performed without adjustment not by using adjustment mechanism, and for that purpose, it is required that the variation in optical specifications of individual lenses is within an intended acceptable range.

However, when a resin die, which is formed by performing transfer and solidification from an original shape by using a resin material in a liquid state, is used as a molding die for forming a plurality of optical element parts, the solidification of the resin material forming the resin die causes generation of shrinkage. Consequently, in the methods described above in the Patent Literatures 1 and 2, it is difficult to control accurately, while calculating the shrinkage of the resin, the difference in relative heights between an abutment surface of the projection to be brought into contact with the base member of the wafer lens and the optical transfer surface in a resin die, and formation as expected is extremely difficult. Furthermore, even when a resin die is formed accurately and the distance from the base member surface on which an optical element part is to be formed to the surface of the optical element part is formed as expected, in the case where a base member has an error in thickness, the thickness of an optical element part that is formed (the thickness from the rear surface of the base member to the surface of the optical element part) has directly the error in the base member thickness. That is, individual optical elements formed of a base member having varied thicknesses have largely different optical properties, which come to light as variation in a focal position when these elements are incorporated in image pickup devices.

### CITATION LIST

### Patent Literature

[Patent Literature 1] Published Japanese translation of PCT patent application No. 2006-519711
[Patent Literature 2] Published Japanese translation of PCT patent application No. 2009-530136

### SUMMARY OF INVENTION

The present invention aims at solving the above-mentioned problem in conventional technologies to provide a method for producing a wafer lens capable of forming a wafer lens provided with a plurality of optical elements having intended properties, and a device for producing a wafer lens.

Furthermore, the present invention aims at providing optical elements having uniform properties that are obtained by the above-mentioned method for producing a wafer lens.

Moreover, the present invention aims at providing optical elements having uniform properties that are obtained by the above-mentioned device for producing a wafer lens.

In order to achieve the above-mentioned purpose, the method for producing a wafer lens according to the present invention is a method for producing a wafer lens, the method forming a resin layer having a plurality of optical surfaces on at least one surface of a flat plate-shaped substrate having light transmittivity, by transfer using a molding die, wherein, when molding the plurality of optical surfaces on the substrate by the molding die, a gap between the molding die and the substrate is adjusted using a positioning device which is provided, independently of the molding die, on at least one of a side of a substrate support member supporting the substrate and a side of a die support member supporting the molding die, and which has an abutment member abutting to the other side when the substrate support member and the die support member come close to each other.

According to the above-mentioned production method, since the positioning device provided independently of the molding die is used for adjusting the gap between the molding die and the substrate, it becomes unnecessary to provide a projection for adjusting the gap that hardly enables to be formed in an estimated way for a molding die, and, in addition, it becomes possible to set the thickness of an optical element based on the optical surface regardless of the thickness of the substrate. Consequently, a wafer lens in which a plurality of optical elements having intended properties, that is, substantially uniform optical specifications can be produced.

According to the specific aspect or viewpoint, the gap between the molding die and the substrate which is made by the positioning device is corrected on the basis of the dimensional error of the wafer lens formed at a previous time. Consequently, the die is not required to be reshaped and the production cost can effectively be reduced.

According to another aspect of the present invention, the positioning device is provided on both of the die support member side and the substrate support member side and has a first abutment member provided on the die support member side and a second abutment member provided on the substrate support member side, and the positioning device adjusts the gap of the molding die and the substrate by changing the projection amount of at least one of the first abutment member and the second abutment member.

Further, in order to achieve the above-mentioned purpose, the device for producing a wafer lens according to the present invention has a substrate support member supporting a flat plate-shaped substrate having light transmittivity, a die support member which is arranged facing the substrate and supports a molding die for molding, by transfer, a resin layer having a plurality of optical surfaces on one surface of the substrate, a lifting device causing the substrate support member and the die support member to come close to and separate from each other, and a positioning device which is provided, independently of the molding die, on at least one side of a substrate support member side and a die support member side and which has an abutment member adjusting the gap between the molding die and the substrate by being abutted to the other side when the substrate support member and the die support member are caused to come close to each other by the lifting device.

According to the above-mentioned production device, since the production device has the positioning device provided independently of the molding die, for adjusting the gap between the molding die and the substrate, it becomes unnecessary to provide, in the molding die, a gap-adjusting projection which is difficult to be formed as expected, and the thickness of the optical element can be set on the basis of the optical surface regardless of the thickness of the substrate. Consequently, there can be produced a wafer lens, in which a plurality of optical elements having intended properties, that is, substantially uniform optical specifications are formed.

According to a specific aspect or viewpoint of the present invention, in the device for producing the above-mentioned wafer lens, the positioning device is provided on the die support member side, and the abutment member is abutted to a predetermined surface that serves as the basis of the arrangement of the substrate. In this case, by the operation of adjusting the position of a predetermined surface to be the basis by means of the abutment member, the thickness of the optical element can simply be brought close to an intended value.

According to another aspect of the present invention, the abutment member is abutted to a surface of a back plate supporting the substrate from behind. In this case, by adjusting the surface position of the back plate by the abutment member, the thickness from the substrate rear surface to the optical surface can be brought close to an intended value regardless of variation in the substrate thickness.

According to still another aspect, the positioning device is provided on the substrate support member side, and the abutment member is abutted to a predetermined surface while avoiding a resin layer constituting the molding die. Also with such a configuration, the thickness from the substrate rear surface to the optical surface can be brought close to an intended value regardless of variation in substrate thickness.

According to still another aspect of the present invention, the positioning device is arranged in three positions around the substrate and the molding die, and makes projection amounts of the abutment members of the positioning device changeable individually. In this case, the inclination relationship between the molding die and the substrate can also be adjusted, and there can be produced a wafer lens in which optical elements having more substantially uniform optical specifications.

According to still another aspect of the present invention, the positioning device is provided on both of the die support member side and the substrate support member side and has a first abutment member provided on the die support member side and a second abutment member provided on the substrate support member side, to abut the first abutment member and the second abutment member to each other.

According to still another aspect of the present invention, the positioning device changes the projection amount of at least one of the first abutment member and the second abutment member, and thus, changes the gap between the molding die and the substrate.

Furthermore, the optical element according to the present invention is one obtained by cutting, into pieces, the wafer lens produced by the above-mentioned method for producing a wafer lens. The optical element obtained in this way is one having intended properties with uniform optical specifications.

Moreover, the optical element according to the present invention is one obtained by cutting, into pieces, the wafer lens produced by the above-mentioned device for producing a wafer lens. The optical element obtained in this way is one having intended properties with uniform optical specifications.

### BRIEF DESCRIPTION OF DRAWINGS

FIG. 1 is a conceptual diagram explaining the production device of a first embodiment.

FIG. 2A is a plan view explaining a positioning device or the like, and FIG. 2B is a side sectional view explaining the positioning device etc.

FIG. 3 is a side view explaining the structure of one abutment device constituting the positioning device.

FIGS. 4A and 4B are drawings explaining the production method of the first embodiment.

FIGS. 5A to 5C are drawings explaining the production method of the first embodiment.

FIG. 6A is a plan view explaining a positioning device to be incorporated in the production device of a second embodiment, and FIG. 6B is a side sectional view of the positioning device in FIG. 6A.

FIG. 7A is a plan view explaining a positioning device to be incorporated in the production device of a third embodiment, and FIG. 7B is a side sectional view of the positioning device in FIG. 7A.

FIGS. 8A and 8B are side sectional views explaining an essential part of the production device of a fourth embodiment.

FIGS. 9A and 9B are drawings explaining a modification of the production device of the fourth embodiment.

FIGS. 10A and 10B are side sectional views explaining an essential part of the production device of a fifth embodiment.

FIGS. 11A to 11C are drawings explaining a production process when a resin layer having a plurality of optical surfaces is formed on both surfaces of a substrate.

FIGS. 12A to 12C are drawings explaining the production process when a resin layer having a plurality of optical surfaces is formed on both surfaces of a substrate.

FIGS. 13A to 13C are drawings explaining a production process when a resin layer having a plurality of optical surfaces is formed on both surfaces of a substrate, and at the same time, a spacer is formed.

FIGS. 14A to 14C are drawings explaining a production process when a resin layer having a plurality of optical surfaces is formed on both surfaces of a substrate, and at the same time, a spacer is formed.

FIGS. 15A and 15B are drawings explaining a production process when a resin layer having a plurality of optical surfaces is formed on both surfaces of a substrate, and at the same time, a spacer is formed.

FIG. 16 is a drawing explaining a modification of the production device of the first embodiment.

### DESCRIPTION OF EMBODIMENTS

### First Embodiment

With reference to the drawings, there will be explained the method for producing a wafer lens and the device for producing a wafer lens according to a first embodiment of the present invention.

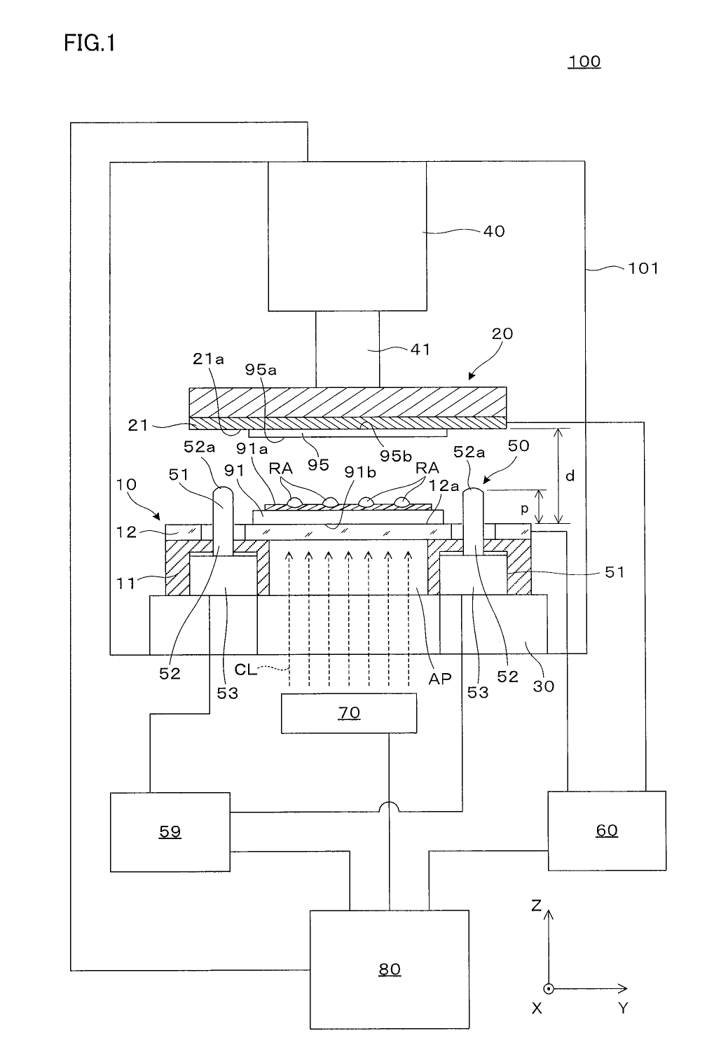

FIG. 1 is a drawing explaining conceptually a device for producing a wafer lens. An illustrated production device 100 is provided with a first attachment member 10 on a side to which a molding die is to be attached, a second attachment member 20 on a side to which a flat-plate shaped substrate having light transmittivity is to be attached, a stage 30, a lifting device 40, a positioning device 50, a detachable drive part 60, a light source part 70 and a control part 80.

In the production device 100, the first attachment member 10 is a die support member that supports a rear surface 91b of a molding die 91 from the under side, and has a base part 11 supported by the stage 30, and a back plate 12 fixed on the base part 11. To the base part 11, a plurality of abutment devices 51 constituting the positioning device 50 is fixed. The back plate 12 is a flat-plate shaped suction jig having a suction part (not shown) built-in that operates by being driven by the detachable drive part 60, which can perform suction of and fix the molding die 91 onto a surface 12a thereof, and can release the molding die 91 by stopping the suction of the molding die 91 for the surface 12a. The back plate 12 is formed of a light-transmissive material, and can cause curing light CL from the light source part 70, to enter the molding die 91 via an opening AP of the base part 11.

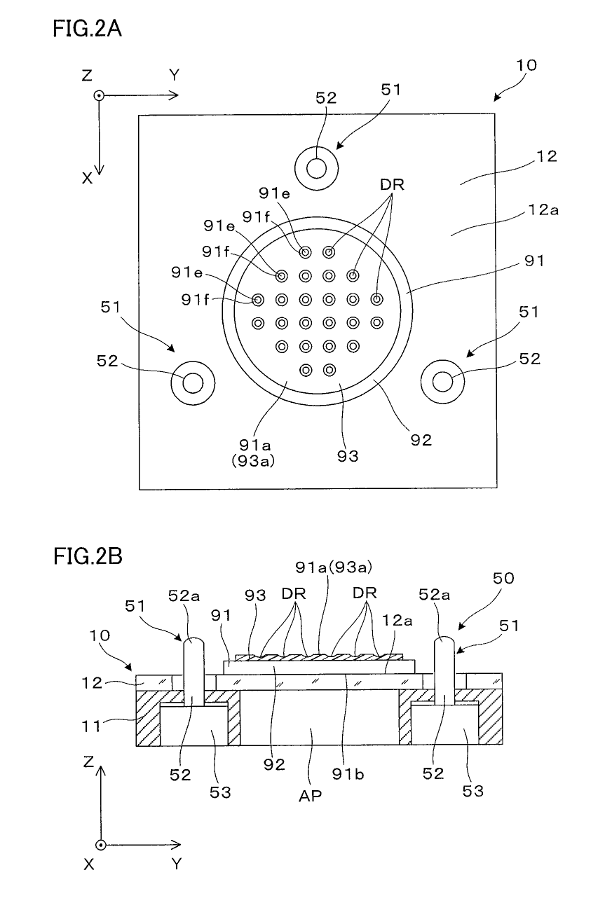

Meanwhile, the molding die 91 to be attached to the first attachment member 10 is, as shown in FIG. 2, provided with a transparent substrate 92 and a light-transmissive resin layer 93 formed on the transparent substrate 92. On a front surface 93a of the resin layer 93, that is, a front surface 91a of the molding die 91, a depressed part DR is formed. The periphery of the depressed part DR is substantially flat. Here, a surface of the depressed part DR is an optical transfer surface 91e to be described later, and a surface around the depressed part DR is a flange transfer surface 91f. The molding die 91 has, as shown in FIG. 1, comparatively high transmittance relative to the curing light CL emitted from the light source part 70. The molding die 91 can be formed by transfer, for example, from an original molding die. Specifically, by sandwiching a resin material in a liquid state between a flat plate-shaped transparent substrate and an original molding die and solidifying it by light curing or the like, the shape of the original molding die is transferred and the molding die 91 having a reversed shape is obtained. Here, the original molding die may also be one formed by transfer, further from an original master.

The second attachment member 20 is a substrate support member that supports, on a rear surface 95b side, a transparent substrate 95, which is a flat plate-shaped substrate having light transmittivity to constitute a part of a wafer lens WL to be described later, and has a back plate 21 in a lower part. The back plate 21 is a flat plate-shaped suction jig having a suction part (not shown) built-in that operates by being driven by the detachable drive part 60, which can perform suction of and fix the transparent substrate 95 onto a surface 21a thereof, and can release the transparent substrate 95 by stopping the suction of the transparent substrate 95 for the surface 21a thereof.

The stage 30 can be moved finely and two-dimensionally along an XY plane in a state of supporting the first attachment member (die support member) 10, and can align and arrange the molding die 91 supported on the first attachment member 10, in the XY direction relative to the transparent substrate 95 fixed to the second attachment member 20. By constituting the stage 30 so as to be rotatable in the XY plane, it may also be possible to perform the alignment in the rotation direction.

The lifting device 40 has a support shaft member 41 that expands and contracts, and can move the second attachment member (substrate support member) 20 up and down in the Z direction. Because of this, the transparent substrate 95 fixed to the second attachment member 20 can be advanced or retreated in the Z direction in a state of facing the molding die 91 supported on the first attachment member 10, to thereby cause the first attachment member 10 and the second attachment member 20 to come close to and separate from each other.

The stage 30 supporting the first attachment member 10 and the lifting device 40 supporting the second attachment member 20 are fixed to a frame 101 surrounding the whole.

The positioning device 50 is provided on the first attachment member (die support member) 10 side and has a plurality of abutment devices 51, and each of abutment devices 51 is provided with a rod part 52 projecting from the first attachment member 10 and a displacement device 53 driving and displacing the rod part 52. The rod part 52 functions as an abutment member for adjusting a gap, which is abutted to the surface 21a of the back plate 21 of the second attachment member 20 that serves as the basis of the arrangement of the transparent substrate 95.

FIGS. 2A and 2B are a plan view and a side sectional view explaining the positioning device 50 and the like. The positioning device 50 has three abutment devices 51, and these abutment devices 51 are arranged at substantially uniform intervals around the molding die 91 so as to surround the molding die 91 fixed to the first attachment member 10 from the periphery. Each of abutment devices 51 is fixed so as to be embedded in the base part 11 of the first attachment member 10.

Returning to FIG. 1, the rod part (abutment member) 52 of respective abutment devices 51 is driven by the displacement device 53 and moves up and down in the Z direction. The displacement device 53 moves the rod part 52 up and down by an intended amount, and thus, adjusts a projection amount p of the rod part 52 from the first attachment member 10. For the displacement device 53, along with this, a sensor (not shown) monitoring the projection amount p of the rod part 52 can be provided. Each of abutment devices 51 is driven by an expansion/contraction drive part 59 under the control of the control part 80 and operates in synchronization with each other, to thereby move three rod parts 52 up and down in the same way in the Z direction. Consequently, when the first attachment member 10 and the second attachment member 20 are caused to come close to each other, a gap d between the first attachment member 10 and the second attachment member 20 (a gap d0 in the closest state) can be adjusted precisely. In addition, it is also possible to displace three rod parts 52 in the Z direction by individually different amounts and to adjust finely the tilt of the second attachment member 20 relative to the first attachment member 10 (tilt correction). As a result, the tilt between the molding die 91 and the transparent substrate 95 can be corrected to lead to a precise parallel state, and there can be produced the wafer lens WL, in which optical elements with more uniform optical specifications are formed.

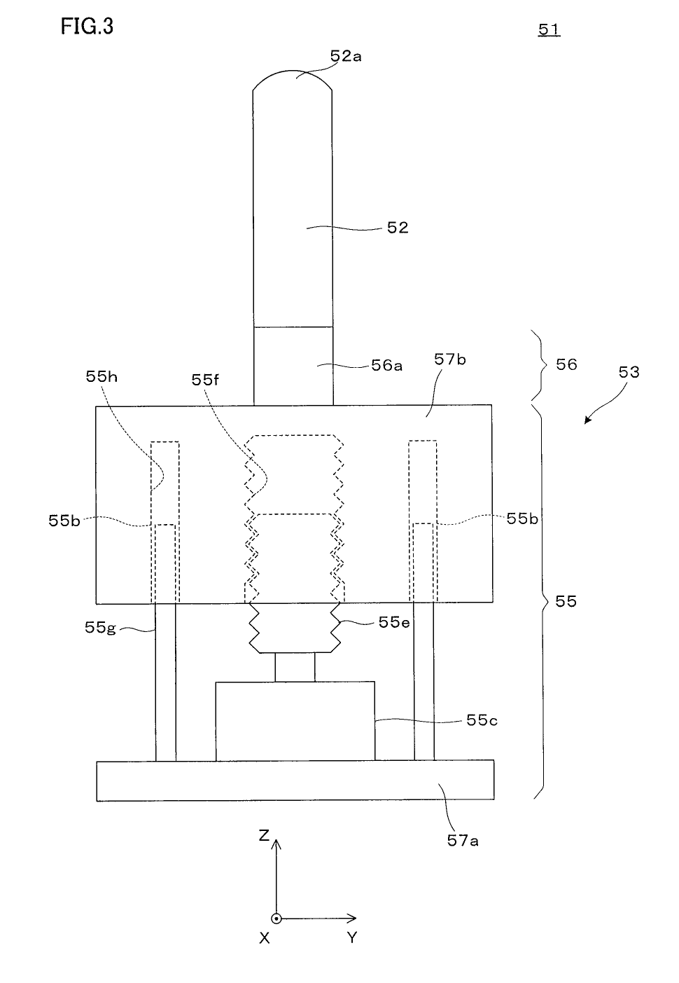

FIG. 3 is a side view exemplifying the structure of one abutment device 51 constituting the positioning device 50 shown in FIG. 1 and the like. The displacement device 53 on the root side of the abutment device 51 is provided with a coarse motion part 55 and a fine motion part 56. The coarse motion part 55 is one that moves a second member 57b up and down largely relative to a first member 57a. The coarse motion part 55 has a guide 55b, a rotary drive part 55c, a male screw part 55e and a female screw part 55f. The guide 55b has a guide rod 55g and a guide hole 55h. The rotary drive part 55c is composed of a motor and the like. In the coarse motion part 55, by operating the rotary drive part 55c, the male screw part 55e rotates, and along with this, the second member 57b, the rotation of which is regulated by the guide 55b, moves up and down in the Z direction by an intended amount. In contrast, the fine motion part 56 is formed of a piezoelectric element 56a or the like, and can move precisely, by expansion and contraction of itself, the rod part 52 up and down in the Z direction by a fine amount at intervals finer than those by the coarse motion part 55.

Meanwhile, a tip 52a of the rod part 52 is processed into a convex curved surface such as a spherical surface. Consequently, in supporting the surface 21a of lower end of the second attachment member 20 that descends by the tip 52a of the rod part 52, stable support can be achieved by a point-like contact.

Returning to FIG. 1, under control of the control part 80, the detachable drive part 60 operates or stops the not shown suction part provided on the back plate 12 of the first attachment member 10, and thus, makes attaching and detaching of a member (in FIG. 1, the molding die 91) to/from the first attachment member 10 possible. In addition, under control of the control part 80, the detachable drive part 60 operates or stops the not shown suction part provided on the back plate 21 of the second attachment member 20, and thus, makes attaching and detaching of a member (in FIG. 1, the transparent substrate 95) to/from the second attachment member 20 possible.

The light source part 70 operates under control of the control part 80 and performs irradiation with curing light over the first attachment member 10, and cures a light curable-type resin agent RA locally filled between the molding die 91 supported by the first attachment member 10 and the transparent substrate 95 fixed to the second attachment member 20. Meanwhile, the light source part 70 is also acceptable, in which the light curable-type resin agent RA is filled on substantially the whole surface of the resin layer 93 of the molding die 91 and is cured.

Hereinafter, a method for producing a wafer lens using a production device 100 in FIG. 1 will be explained specifically.

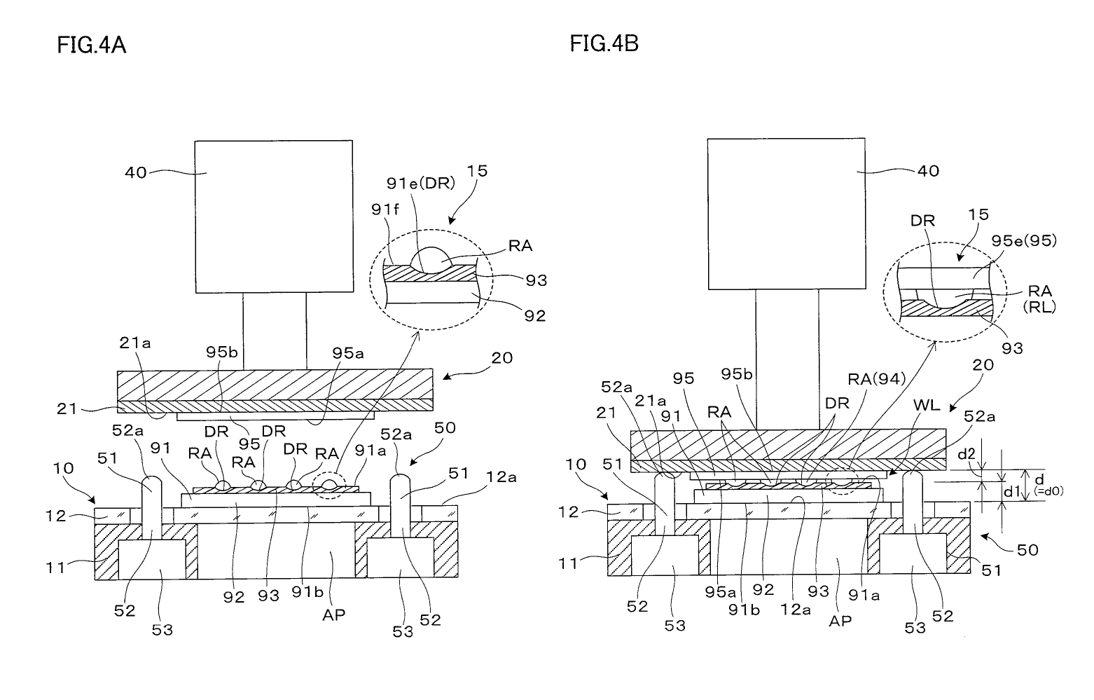

First, as shown in FIG. 4A, a molding die 91 is mounted on an upper part of the first attachment member 10. At this time, the back plate 12 supports the rear surface 91b of the molding die 91 while subjecting it to suction.

Furthermore, as shown in FIG. 4A, the transparent substrate 95 is fixed to a lower part of the second attachment member 20. At this time, the back plate 21 supports the rear surface 95b of the transparent substrate 95 while subjecting it to suction. In this state, by the stage 30 (see FIG. 1), there is performed alignment adjustment between the molding die 91 supported on the first attachment member 10 and the transparent substrate 95 fixed to the second attachment member 20.

Next, as shown in FIG. 4A, to each of depressed parts DR formed on the front side of the molding die 91 mounted on the first attachment member 10, the light curable-type resin agent RA is supplied. Specifically, a dispenser for injecting the light curable-type resin agent RA is prepared, and the resin agent RA in a liquid state is supplied so as to cover sufficiently the optical transfer surface 91e formed on the molding die 91 and the flange transfer surface 91f in periphery thereof. In this case, the resin agent RA in a liquid state is supplied to each of depressed parts DR or optical transfer surfaces 91e, in an independent and separated state.

After that, as shown in FIG. 4B, the lifting device 40 is operated to move the second attachment member 20 downward. Consequently, the back plate 21 of the second attachment member 20 makes contact with the tip 52a of the rod part 52 of each of abutment devices 51 constituting the positioning device 50. At this time, an upper limit is set on pressure for moving down the second attachment member 20 by the lifting device 40, and the downward movement of the second attachment member 20 is stopped to define a gap d between the upper surface of the first attachment member 10 (that is, the surface 12a) and the lower surface of the second attachment member 20 (that is, the surface 21a). That is, the distance from the rear surface 91b of the molding die 91 to the rear surface 95b of the transparent substrate 95 is defined. At this time, by previously adjusting the position of the tip 52a in consideration of the thickness d1 from the rear surface 91b of the transparent substrate 92 of the molding die 91 to the front side surface 91a of the resin layer 93, the distance d2 from the front side surface 91a of the molding die 91 to the rear surface 95b of the transparent substrate 95 can precisely be set at a target value.

Next, the light source part 70 shown in FIG. 1 is operated to perform irradiation with curing light over the first attachment member 10 for curing the light curable-type resin agent RA filled locally in the depressed part DR and the periphery thereof between the molding die 91 and the transparent substrate 95, to thereby make a resin layer part RL having an optical surface. At this time, the resin layer part RL may be heated to cure, more reliably, the resin layer part RL. By such shape transfer, many resin layer parts RL are formed on the transparent substrate 95, to produce the wafer lens WL. The entire combination of a plurality of resin layer parts RL is a resin layer 94 covering a front side surface 95a of the transparent substrate 95. Furthermore, each resin layer part RL and a part 95e of the transparent substrate 95 facing it constitutes an optical element 15 that functions as a lens or the like.

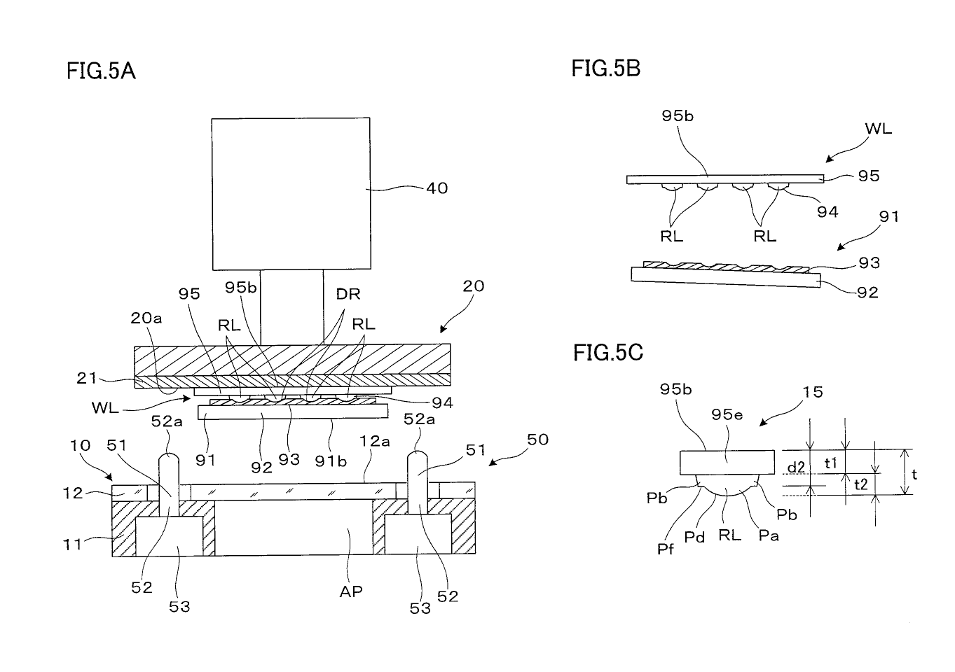

Next, as shown in FIG. 5A, the suction of the molding die 91 by the first attachment member 10 is released, and the lifting device 40 is operated to raise the second attachment member 20. Consequently, the transparent substrate 95, that is, the wafer lens WL, subjected to suction by the second attachment member 20 rises, and along with this, the molding die 91 also rises. Here, the molding die 91 is in a state of being caused to adhere to the transparent substrate 95 by the cured resin layer part RL.

After that, the suction of the transparent substrate 95 by the second attachment member 20 is released, the wafer lens WL is taken out of the production device 100 together with the molding die 91, and the wafer lens WL is separated from the molding die 91 (see FIG. 5B).

The wafer lens WL obtained in this way is cut between resin layer parts RL, into optical elements 15 corresponding to individual resin layer parts RL (see FIG. 5C). The optical element 15 has the part 95e of the transparent substrate 95 and the separated resin layer part RL, and the resin layer part RL has an optical surface part Pa and a flange part Pb. The surface of the optical surface part Pa is, in this case, a concave optical surface Pd. In addition, thickness t of the optical element 15 is one obtained by adding the largest thickness t2 of the resin layer part RL to thickness t1 of the transparent substrate 95. As explained while referring to FIG. 4B, by positioning utilizing the abutment device 51, the distance d2 from the front side surface 91a of the molding die 91 to the rear surface 95b of the transparent substrate 95 can be adjusted, with a simple operation, to a target value. As a result, since the thickness t of the optical element 15 can be brought close to a target value, individual optical elements 15 obtained by cutting are those that have intended properties with uniform optical specifications. Meanwhile, even when the thickness of the transparent substrate 95 varies locally or the thickness t1 fluctuates by variation in thickness among a plurality of transparent substrates 95, the distance d2 corresponding to a wall thickness and the thickness t of the optical element 15 are kept constant, which enables the fluctuation in optical properties to be reduced. This is because the difference in refractive indices between the transparent substrate 95 and a resin that forms the optical surface part Pa is small, and even if the thickness of the optical surface and the thickness of the substrate vary, when the thickness from the rear surface of the base member to the surface of the optical element part, that is, when optical plane thickness+substrate thickness is equal, substantially the same optical properties are obtained.

Furthermore, in the production method of the present embodiment, since the abutment device 51 of the positioning device 50 is given an adjust function, for example, when there is a dimensional error exceeding the allowance in a wafer lens WL obtained by the first transfer, a correction of suppressing the dimensional error can be performed in the second and subsequent times and remolding of the die is unnecessary. Therefore, productivity is enhanced and production cost can be reduced. In particular, when the configuration of the positioning device 50 by the use of three abutment devices 51 makes tilt correction possible, the smaller difference in thickness of the wafer lens WL according to its position can make it possible to further reduce the variation in thicknesses t of optical elements 15.

According to the production method and production device of the first embodiment explained as described above, in order to adjust the gap between the molding die 91 and the transparent substrate 95, the positioning device 50 provided independently of the molding die 91 is used, and thus the provision of a gap-adjusting projection for the molding die 91 becomes unnecessary, and regardless of the thickness of the transparent substrate 95, the thickness of the optical element 15 based on the optical surface Pd can be set. Consequently, there can be formed the wafer lens WL, which has intended properties, that is, which is provided with a plurality of optical elements 15 having substantially uniform optical specifications. Furthermore, by cutting the wafer lens WL into pieces, optical elements 15 having substantially uniform optical specifications can be produced easily on a mass scale.

### Second Embodiment

Hereinafter, the device for producing a wafer lens according to a second embodiment will be explained. Meanwhile, the present embodiment is a modification of the production device of the first embodiment, and parts or items that are not particularly explained are the same as the case in the first embodiment.

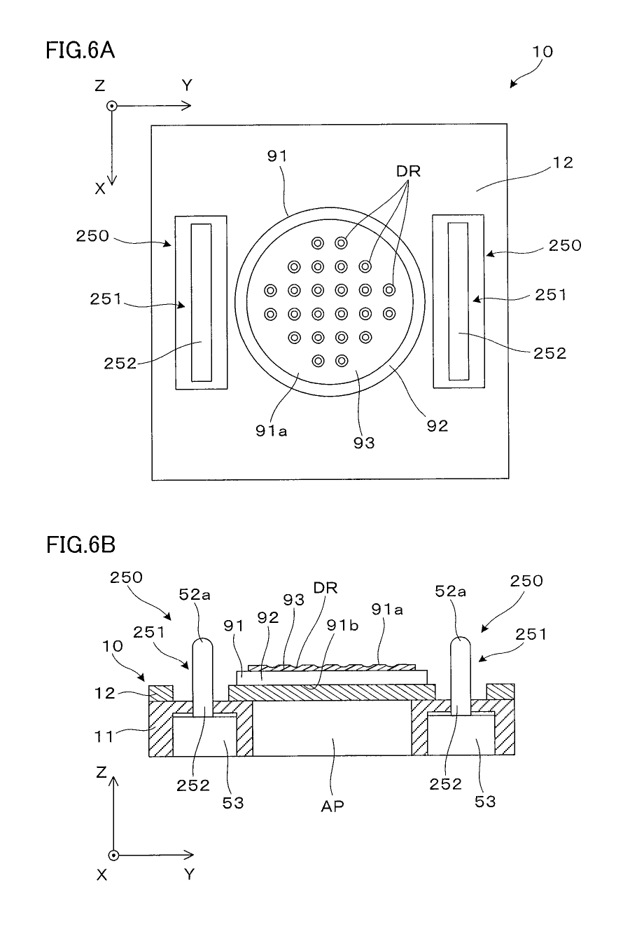

FIGS. 6A and 6B are a plan view and a side sectional view explaining a positioning device or the like to be incorporated in the production device of the second embodiment. A shown positioning device 250 has two abutment devices 251, and both abutment devices 251 are arranged facing each other in the horizontal direction so as to sandwich the molding die 91 fixed to the first attachment member 10.

Each of the abutment devices 251 is provided with a block part 252 projecting from the first attachment member 10, and the displacement device 53 that drives and displaces the block part 252. The block part 252 is provided on the molding die 91 side, and functions as an abutment member for adjusting a gap to be abutted to the surface 21a of the back plate 21 of the second attachment member 20 that serves as the basis of the arrangement of the transparent substrate 95. The block part (abutment member) 252 is a member extending, for example, in the XZ direction, and is driven by the displacement device 53 to move up and down in the Z direction while keeping the attitude.

A pair of abutment devices 251 operate in synchronization with each other driven by the expansion/contraction drive part 59 (see FIG. 1), and move two block parts 252 up and down in the same way in the Z direction. Because of this, in the same way as in the case in FIG. 4B, when the first attachment member 10 and the second attachment member 20 are caused to come close to each other, the gap d between the first attachment member 10 and the second attachment member 20, eventually, the thickness t of the optical element 15 can be adjusted precisely regardless of the variation in the thickness of the transparent substrate 95. By such a configuration, the contact part of the abutment member becomes a line shape and durability such as abrasion resistance can be enhanced.

### Third Embodiment

Hereinafter, the device for producing a wafer lens according to a third embodiment will be explained. Meanwhile, the present embodiment is a modification of the production device of the first embodiment, and parts or items that are not particularly explained are the same as the case in the first embodiment.

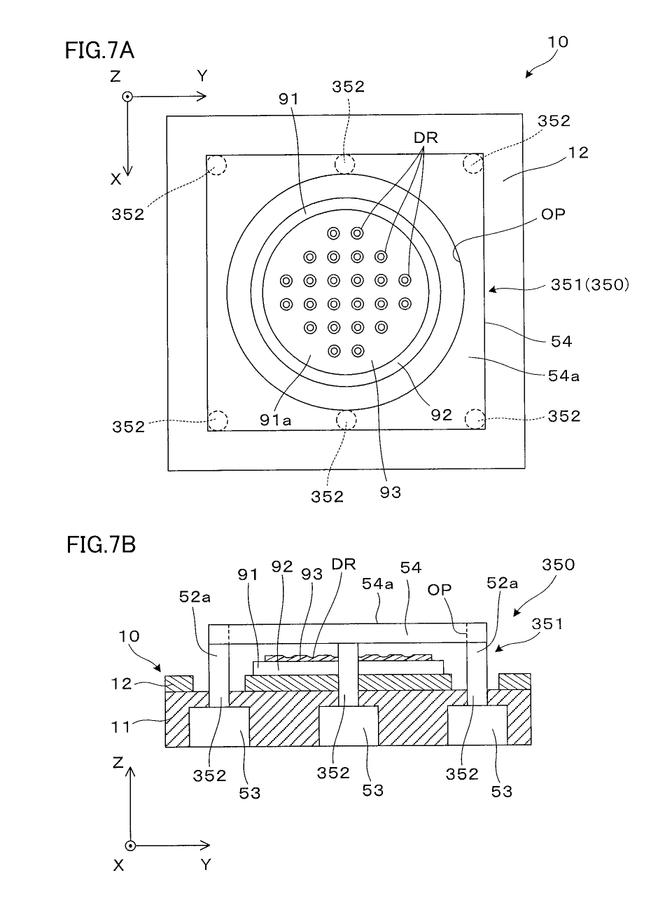

FIGS. 7A and 7B are a plan view and a side sectional view that explain a positioning device etc. to be incorporated in the production device of the third embodiment. The shown positioning device 350 is constituted by a single abutment device 351. The abutment device 351 is provided with a plurality of rod parts 352 projecting from the first attachment member 10, a plurality of displacement devices 53 driving and displacing these rod parts 352, and a ring-shaped contact member 54 fixed to tips 52a of a plurality of rod parts 352. The contact member 54 has, in order to avoid interference with the molding die 91 upon up-and-down movement, an opening OP of a size larger than the diameter of the molding die 91. The contact member 54 is provided on the molding die 91 side, and functions as an abutment member for adjusting a gap to be abutted to the surface 21a of the back plate 21 of the second attachment member 20, which serves as the basis of the arrangement of the transparent substrate 95.

The abutment device 351 is driven by the expansion/contraction drive part 59 in FIG. 1 to operate, and moves the contact member (abutment member) 54 up and down in the same way in the Z direction. Consequently, in the same way as in the case in FIG. 4B, when the first attachment member 10 and the second attachment member 20 are made closer to each other, the gap d between the first attachment member 10 and the second attachment member 20, eventually, the thickness t of the optical element 15 can be adjusted precisely regardless of the variation in the thickness of the transparent substrate 95. By such a configuration, the contact part of the abutment member becomes a plane shape and durability such as abrasion resistance can be enhanced.

### Fourth Embodiment

Hereinafter, the device for producing a wafer lens according to a fourth embodiment will be explained. Meanwhile, the present embodiment is a modification of the production device of the first embodiment, and parts or items that are not particularly explained are the same as the case in the first embodiment.

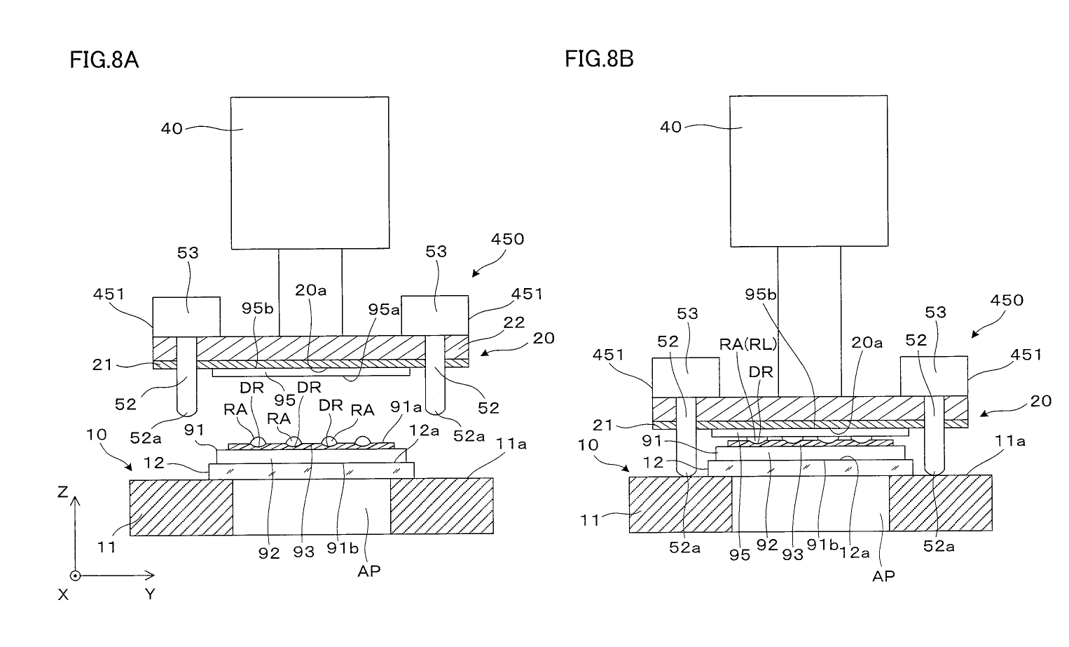

As shown in FIGS. 8A and 8B, a positioning device 450 to be incorporated in the production device of the fourth embodiment is provided on the second attachment member (substrate support member) 20 side. A plurality of abutment devices 451 constituting the positioning device 450 has a structure similar to that of the abutment device 51 of the first embodiment shown in FIG. 1 and the like, but is fixed so as to be embedded in a base part 22 of the second attachment member (substrate support member) 20. The rod part 52 of each of abutment devices 451 functions, in positioning of the molding die 91 and the transparent substrate 95 as shown in FIG. 8B, as an abutment member for adjusting a gap to be abutted to a surface 11a of the base part 11 of the first attachment member 10, which serves as the basis of arrangement of the molding die 91.

In the case of the fourth embodiment, in order to adjust the gap between the rear surface 91b of the molding die 91 and the rear surface 95b of the transparent substrate 95, the positioning device 450 is provided on the second attachment member (substrate support member) 20 side, and this also makes it possible to adjust the thickness t of the optical element 15 to an intended value regardless of the variation in the thickness of the transparent substrate 95. Such a configuration can also produce the same effect as that in the first embodiment.

Meanwhile, in the example shown in FIGS. 8A and 8B, the tip 52a of the rod part 52 provided at the abutment device 451 is abutted to the surface 11a of the base part 11, but various modifications are possible.

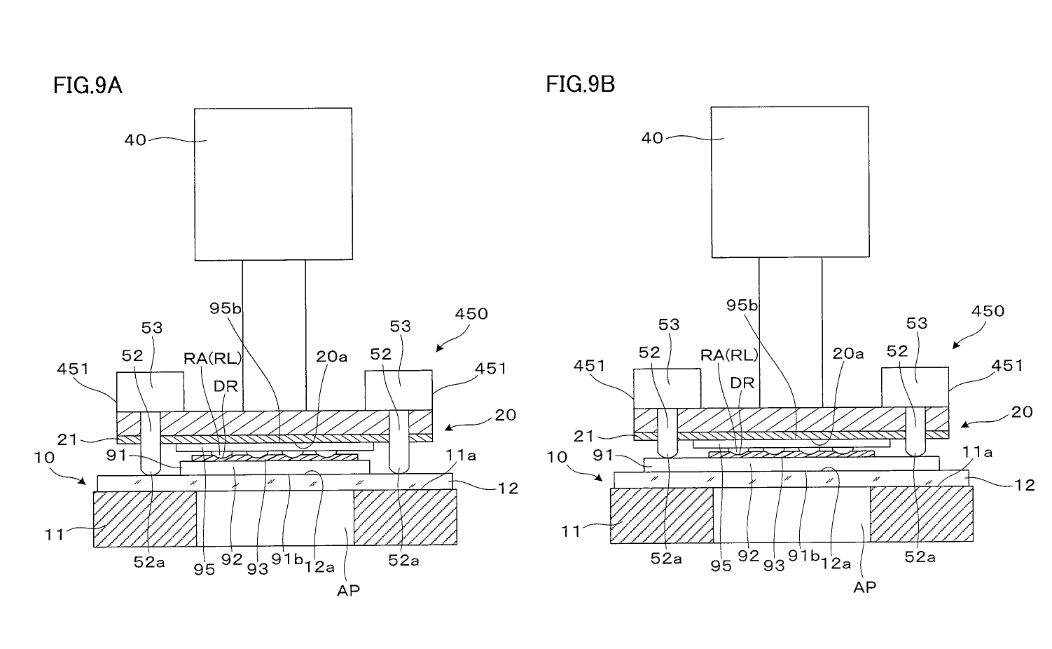

FIGS. 9A and 9B are drawings explaining modifications of the production device of the fourth embodiment.

The example shown in FIG. 9A is an example in which the tip 52a of the rod part 52 provided at the abutment device 451 is abutted to the surface of the back plate 12. In addition, the example shown in FIG. 9B is an example in which the tip 52a of the rod part 52 provided at the abutment device 451 is abutted to the surface of the transparent substrate 92 constituting the molding die 91. These configurations can also adjust the thickness t of the optical element 15 to an intended value regardless of the variation in the thickness of the transparent substrate 95.

### Fifth Embodiment

Hereinafter, the device for producing a wafer lens according to a fifth embodiment will be explained. Meanwhile, the present embodiment is a modification of the production device of the first embodiment, and parts or items that are not particularly explained are the same as the case in the first embodiment.

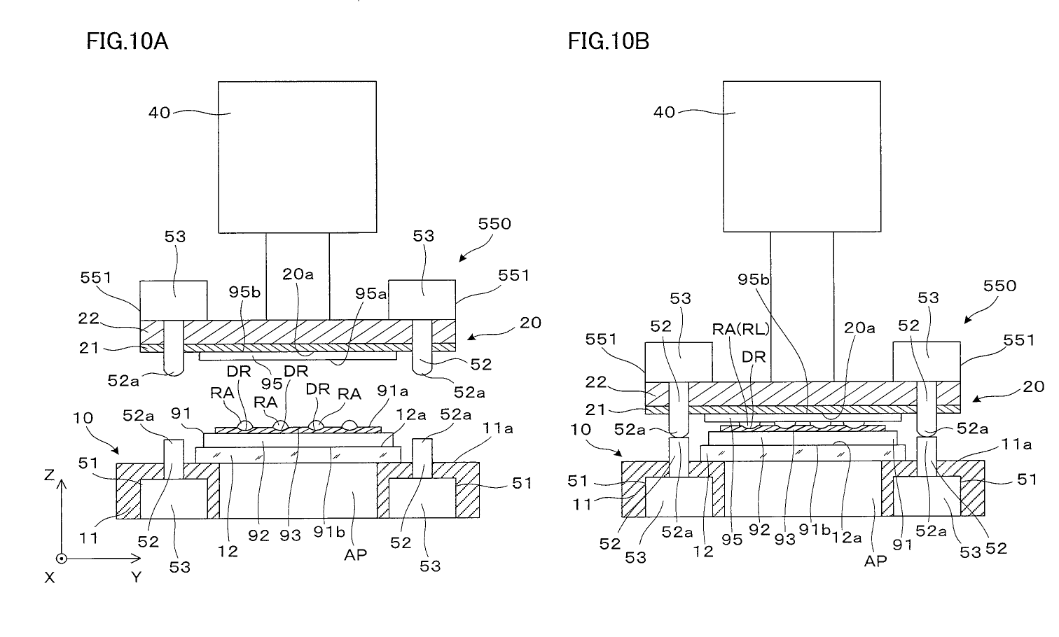

As shown in FIGS. 10A and 10B, a positioning device 550 to be incorporated in the production device of the fifth embodiment is provided at both the first attachment member (die support member) 10 and the second attachment member (substrate support member) 20. The first abutment device 51 constituting the positioning device 550 is provided on the first attachment member (die support member) 10 side and has the same structure as that of the abutment device 51 of the first embodiment shown in FIG. 1 and the like. In addition, a second abutment device 551 constituting the positioning device 550 is provided on the second attachment member (substrate support member) 20 side and has the same structure as that of the abutment device 451 of the fourth embodiment shown in FIG. 8A and the like.

In positioning of the molding die 91 and the transparent substrate 95 as shown in FIG. 10B, the tip 52a of the first rod part (first abutment member) 52 provided at the first abutment device 51 and the end part 52a of the second rod part (second abutment member) 52 provided at the second abutment device 551 make contact with each other. Consequently, by changing at least one of projection amounts of the first rod part 52 and the second rod part 52, the gap between the rear surface 91b of the molding die 91 and the rear surface 95b of the transparent substrate 95 can be adjusted. At this time, the tip 52a of the rod part 52 provided at the first abutment device 51 is made flat, and the tip 52a of the rod part 52 provided at the second abutment device 551 is made to be a projection of a curved surface. Consequently, reliability of positioning between the molding die 91 and the transparent substrate 95 can be enhanced. Such a configuration can make adjustable range of the gap between the first attachment member (die support member) 10 and the second attachment member (substrate support member) 20 larger than that in the case where a positioning device is arranged on one side.

Hereinafter, there will be explained a process of forming a resin layer on both surfaces of the transparent substrate 95 using devices 100 for producing a wafer lens according to the above-mentioned first to fifth embodiments. Meanwhile, an embodiment shown below is an example when the production device 100 of the first embodiment is used, and parts or items not particularly explained are the same as in the case of the first embodiment.

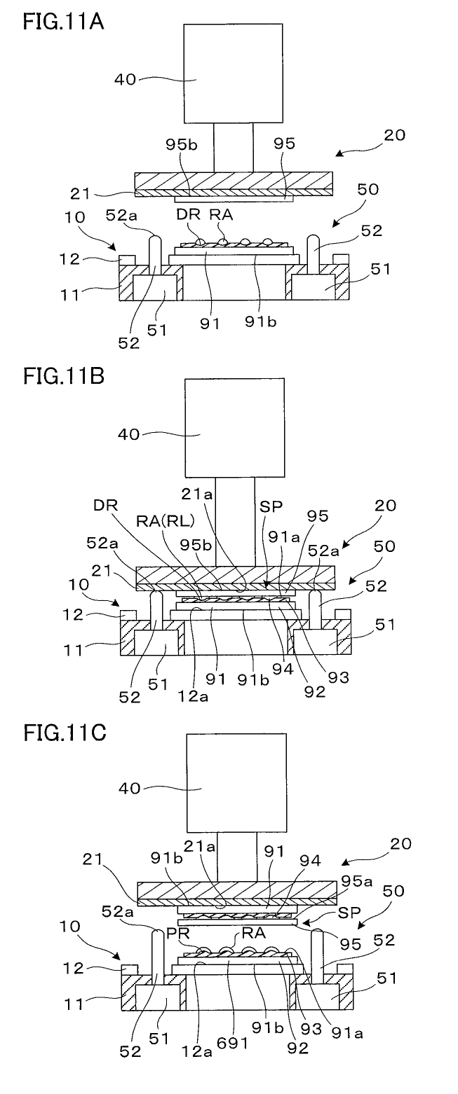

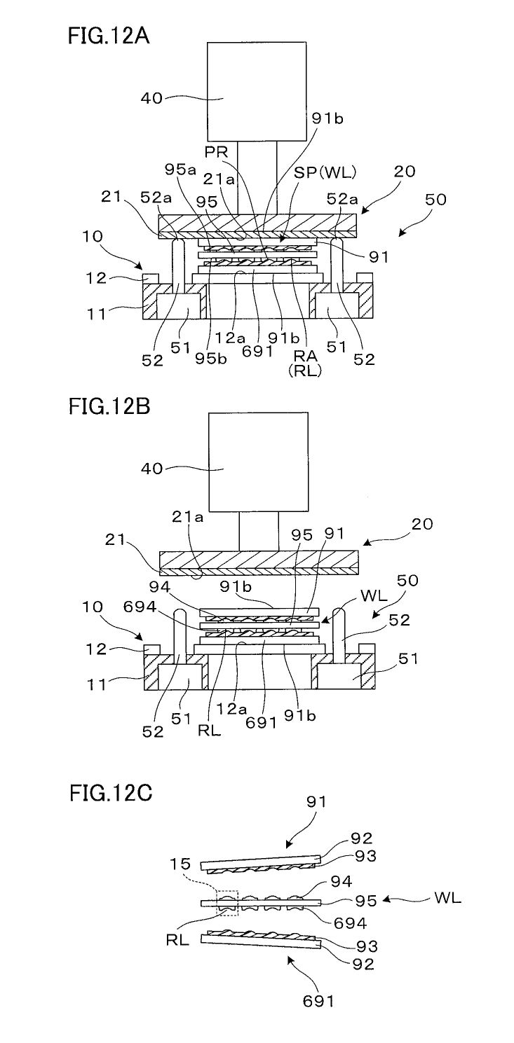

Hereinafter, while referring to FIGS. 11 and 12, there will be explained a process of producing the wafer lens WL when a resin layer is formed on both surfaces of the transparent substrate 95.

First, as shown in FIG. 11A, the first molding die 91 is fixed to the first attachment member 10 and the transparent substrate 95 is fixed to the second attachment member 20. In this state, to each of depressed parts DR formed on the front side of the first molding die 91 fixed on the first attachment member 10 and to peripheries thereof, the light curable-type resin agent RA in a liquid state is supplied respectively.

After that, as shown in FIG. 11B, the lifting device 40 is operated to move the second attachment member 20 downward. The downward movement of the second attachment member 20 is continued until the surface 21a of the back plate 21 makes contact, by constant force, with the tip 52a of the rod part 52 of respective abutment devices 51 constituting the positioning device 50. Consequently, the gap d between the surface 12a of the first attachment member 10 and the surface 21a of the second attachment member 20 is defined. At this time, by previously adjusting the position of the tip 52a in consideration of the thickness from the rear surface 91b of the transparent substrate 92 of the molding die 91 to the front side surface 91a of the resin layer 93, a distance from the front side surface 91a of the molding die 91 to the rear surface 95b of the transparent substrate 95 is set to be a target value.

Next, the light source part 70 shown in FIG. 1 is operated to illuminate the transparent substrate 95 or the like over the first attachment member 10 and to cure the light curable-type resin agent RA filled locally in depressed parts DR and peripheries thereof between the first molding die 91 and the transparent substrate 95, thereby making the resin layer part RL. One having many resin layer parts RL formed, by such shape transfer, on the transparent substrate 95 is a semi-finished product SP of the wafer lens WL (see FIG. 11C). In the semi-finished product SP, the whole of combination of a plurality of resin layer parts RL serves as the first resin layer 94 covering the front side surface 95a of the transparent substrate 95.

Next, as shown in FIG. 11C, the suction of the first molding die 91 by the first attachment member 10 is released to raise the second attachment member 20 by the lifting device 40, and the suction of the transparent substrate 95, that is, the semi-finished product SP by the second attachment member 20 is released and both sides of the semi-finished product SP are reversed to be subjected to suction again by the second attachment member 20. Consequently, the semi-finished product SP is fixed to the second attachment member 20 via the first molding die 91. Furthermore, to the first attachment member 10, a second molding die 691 is fixed. In this state, to each of projections PR formed on the front side of the second molding die 691 fixed on the first attachment member 10 and peripheries thereof, the light curable-type resin agent RA in a liquid state is supplied respectively. Meanwhile, for preparing for the subsequent process, the height position of the tip 52a of the rod part 52 of each of abutment devices 51 provided in the positioning device 50 is corrected toward an upper side. At this time, the position of the tip 52a is adjusted in consideration of the thickness from the rear surface 91b of the transparent substrate 92 of the second molding die 691 to the front side surface 91a of the resin layer 93.

After that, as shown in FIG. 12A, the lifting device 40 is operated to move the second attachment member 20 downward. The downward movement of the second attachment member 20 is continued until the back plate 21 makes contact, by constant force, with the tip 52a of the rod part 52 of each of abutment devices 51 constituting the positioning device 50. Consequently, the gap d between the surface 12a of the first attachment member 10 and the surface 21a of the second attachment member 20 is defined. That is, the gap between the rear surface 91b of the second molding die 691 and the rear surface 91b of the first molding die 91 is defined.

Next, the light source part 70 shown in FIG. 1 is operated to illuminate the semi-finished product SP or the like over the first attachment member 10 and to cure the light curable-type resin agent RA filled locally in the projection PR and peripheries thereof between the second molding die 691 and the semi-finished product SP, thereby making the resin layer part RL. One having many resin layer parts RL formed, by such shape transfer, on both surfaces 95a and 95b of the transparent substrate 95 serves as the wafer lens WL. On the second molding die 691 side of the wafer lens WL, the whole of combination of a plurality resin layer parts RL serves as a second resin layer 694 that covers the rear surface 95b of the transparent substrate 95 (see FIG. 12B).

Subsequently, the suction of the first molding die 91 by the second attachment member 20 is released to raise the die (see FIG. 12B), the suction of the second molding die 691 by the first attachment member 10 is released, and the wafer lens WL is taken out of the production device 100 together with molding dies 91 and 691 and the wafer lens WL is separated from molding dies 91 and 691 (see FIG. 12C).

The wafer lens WL obtained in this way is cut at positions between resin layer parts RL, into optical elements 15 corresponding to individual resin layer parts RL.

As described above, the wafer lens production device according to the present embodiment is applicable not only to the case where a resin layer having the optical element part is formed on one surface, but also to the case where it is formed on both surfaces, and can be made to have more versatility.

In the explanation described above, there is explained an example in which the production device 100 of the first embodiment is used, but by also using production devices 100 explained in the second to fifth embodiments, the resin layer can be formed on both surfaces of the transparent substrate 95 by a similar process.

Hereinafter, there will be explained a process, in which a resin layer having a plurality of optical surfaces is formed on both surfaces of the transparent substrate 95 by using devices 100 for producing a wafer lens according to the above-mentioned first to fifth embodiments, and along with this, a spacer 98 is formed. Meanwhile, an embodiment shown below is an example of the case where the production device 100 of the first embodiment is used, and parts or items that are not particularly explained is the same as in the case of the first embodiment.

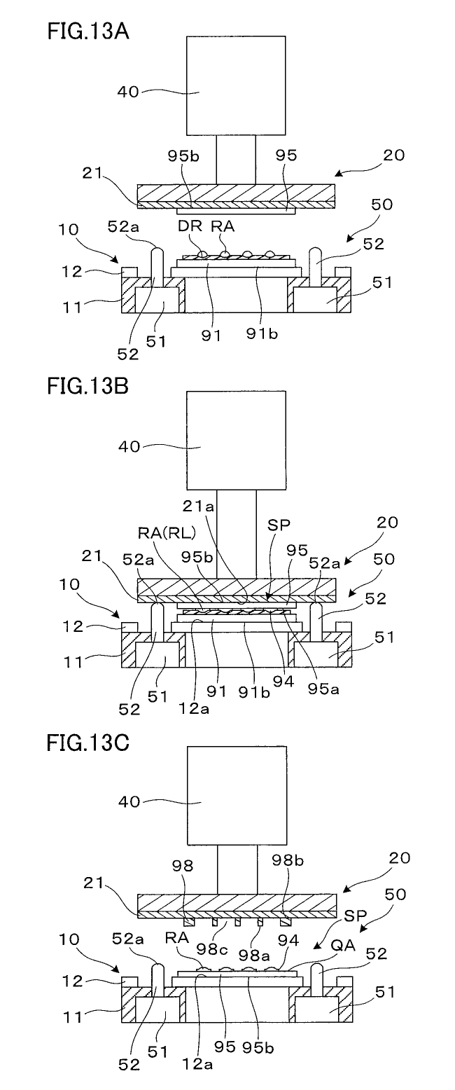

Hereinafter, with reference to FIGS. 13 to 15, there will be explained a production process of the wafer lens WL, in which a resin layer having a plurality of optical surfaces is formed on both surfaces of the transparent substrate 95, and at the same time, the spacer 98 is formed.

First, as shown in FIG. 13A, the first molding die 91 is fixed to the first attachment member 10 and the transparent substrate 95 is fixed to the second attachment member 20. In this state, to each of depressed parts DR formed on the front side of the first molding die 91 fixed on the first attachment member 10 and peripheries thereof, the light curable-type resin agent RA in a liquid state is supplied respectively.

After that, as shown in FIG. 13B, the lifting device 40 is operated to move the second attachment member 20 downward. The downward movement of the second attachment member 20 is continued until the back plate 21 makes contact, by constant force, with the tip 52a of the rod part 52 of each of abutment devices 51 constituting the positioning device 50.

Next, the light source part 70 shown in FIG. 1 is operated to illuminate the transparent substrate 95 or the like over the first attachment member 10 and to cure the light curable-type resin agent RA filled locally in the depressed part DR and peripheries thereof between the first molding die 91 and the transparent substrate 95, thereby making the resin layer part RL. One having many resin layer parts RL formed, by such a shape transfer, on the transparent substrate 95 becomes the semi-finished product SP of the wafer lens WL. In the semi-finished product SP, the whole of combination of a plurality of resin layer parts RL serves as the first resin layer 94 that covers the front side surface 95a of the transparent substrate 95.

Next, the lifting device 40 is operated to raise the second attachment member 20 and the first molding die 91 and the transparent substrate 95 are taken out, and the molding die 91 is separated to make the semi-finished product SP single body. After that, as shown in FIG. 13C, to the back plate 21 of the second attachment member 20, the rear surface 98b side of the lattice-shaped spacer 98 is subjected to suction and fixed, and, to the back plate 12 of the first attachment member 10, the rear surface 95b side of the transparent substrate 95 of the semi-finished product SP is fixed. In this state, to a lower end surface 98a of the spacer 98 fixed to the second attachment member 20 or to a periphery part of the resin layer part RL of the semi-finished product SP fixed on the first attachment member 10, a light curable-type resin agent QA in a liquid state is coated thinly. The spacer 98 has a through-hole 98c in order to avoid the interference with the resin layer part RL constituting the resin layer 94. Meanwhile, for preparing for the subsequent process, the height position of the tip 52a of the rod part 52 of each of abutment devices 51 provided for the positioning device 50 is corrected toward the lower side. At this time, the position of the tip 52a is adjusted so that the distance from the rear surface 95b of the transparent substrate 95 of the semi-finished product SP to the rear surface 98b of the spacer 98 (that is, to the surface of the back plate 21) becomes an intended distance.

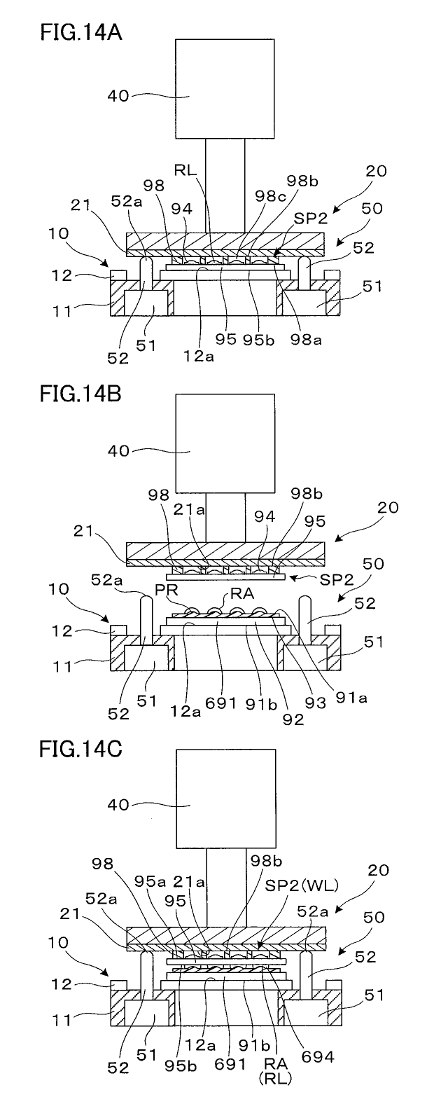

Next, as shown in FIG. 14A, the lifting device 40 is operated to move the second attachment member 20 downward. The downward movement of the second attachment member 20 is continued until the back plate 21 makes contact, by constant force, with the tip 52a of the rod part 52 of each of abutment devices 51 constituting the positioning device 50. Consequently, at the position where the lower end surface 98a of the spacer 98 and the front side surface of the semi-finished product SP come close to each other and the distance from the rear surface 95b of the transparent substrate 95 to a rear surface 98b of the spacer 98 becomes an intended distance, the second attachment member 20 stops.

Next, the light source part 70 shown in FIG. 1 is operated to illuminate transparent substrate 95 or the like over the first attachment member 10 and to cure the light curable-type resin agent QA filled locally between the lower end surface 98a of the spacer 98 and the front side surface of the semi-finished product SP. Consequently, there is formed a semi-finished product SP2, in which the spacer 98 is fixed on the semi-finished product SP. At this time, the position of the tip 52a has been adjusted at the above-mentioned position, and thus, even when there is a variation in the thickness of the spacer 98, the error is absorbed by the change in the thickness of the resin agent RA, and there can be made the semi-finished product SP2, in which the distance from the rear surface 95b of the transparent substrate 95 to the rear surface 98b of the spacer 98 is accurately defined.

Next, as shown in FIG. 14B, the suction of the semi-finished product SP2 by the first attachment member 10 is released, and by the lifting device 40, the semi-finished product SP2 is raised with the second attachment member 20. Furthermore, to the first attachment member 10, the second molding die 691 is fixed. In this state, to each of projections PR formed on the front side of the second molding die 691 fixed on the first attachment member 10 and peripheries thereof, the light curable-type resin agent RA in a liquid state is supplied respectively. Meanwhile, for preparing for the subsequent process, the height position of the tip 52a of the rod part 52 of each of abutment devices 51 provided at the positioning device 50 is corrected toward the upper side. At this time, the position of the tip 52a is adjusted in consideration of the thickness from the rear surface 91b of the transparent substrate 92 of the second molding die 691, to the front side surface 91a of the resin layer 93.

After that, as shown in FIG. 14C, the lifting device 40 is operated to move the second attachment member 20 downward. The downward movement of the second attachment member 20 is continued until the back plate 21 makes contact, by constant force, with the tip 52a of the rod part 52 of each of abutment devices 51 constituting the positioning device 50. Consequently, the gap d between the surface 12a of the first attachment member 10 and the surface 21a of the second attachment member 20 is defined. That is, the gap between the rear surface 91b of the second molding die 691 and the rear surface 98b of the spacer 98 is defined.

Next, the light source part 70 shown in FIG. 1 is operated to illuminate the semi-finished product SP2 or the like over the first attachment member 10 and to cure the light curable-type resin agent RA filled locally in the projection PR and periphery thereof between the second molding die 691 and the semi-finished product SP2, thereby making the resin layer part RL. One having many resin layer parts RL formed, by such shape transfer, on both surfaces 95a and 95b of the transparent substrate 95 serves as the wafer lens WL. On the second molding die 691 side of the wafer lens WL, the whole of combination of a plurality of resin layer parts RL serves as the second resin layer 694 that covers the rear surface 95b of the transparent substrate 95.

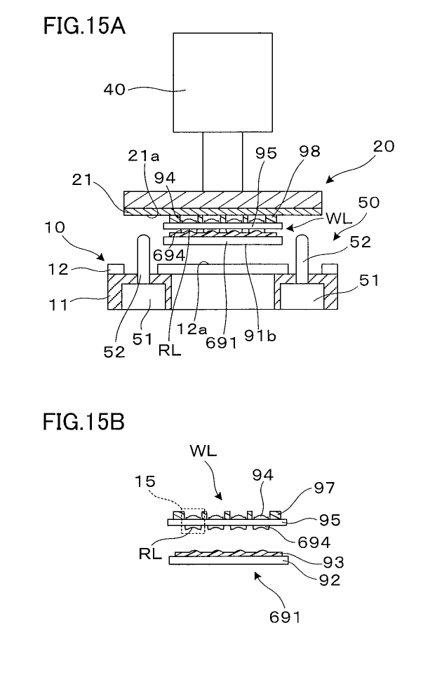

After that, the suction of the second molding die 691 by the first attachment member 10 is released and the second attachment member 20 is raised (see FIG. 15A), the suction of the spacer 98 by the second attachment member 20 is released, and the wafer lens WL is taken out of the production device 100 with the molding die 691 and the wafer lens WL is separated from the molding die 691 (see FIG. 15B).

The wafer lens WL thus obtained is cut at the position of the spacer 98 into pieces of optical elements 15 corresponding to individual resin layer parts RL shown by a broken line.

As described above, the wafer lens production device according to the present embodiment is applicable not only to the case where the resin layer having the optical element part on both surfaces is formed, but also to the case where the spacer 98 is further formed, and can be made to have extreme versatility.

In the above-mentioned explanation, the example in which the production device 100 of the first embodiment is used, has been explained, but the use of production devices 100 explained in the second to fifth embodiments also enables the resin layer to be formed on both surfaces of the transparent substrate, and at the same time, enables the spacer 98 to be formed, in a similar process.

Meanwhile, the present invention is not restricted to above-mentioned embodiments and can be modified appropriately within the scope not departing from the gist thereof.

For example, in the above-mentioned embodiments, the shape of the resin layer 94 on which the wafer lens WL and the optical element 15 are formed and the shape of the resin layer part RL are mere exemplifications, and can be set appropriately in consideration of the application, lamination or the like of the optical element 15. Furthermore, the resin layer 94 is not restricted to one separated into each optical element 15, but may be one that is formed over the whole wafer lens WL in seamless manners.

In addition, in the above-mentioned embodiments, the resin layer 94 and the like are to be formed from the light curable-type resin agent RA and the resin agent RA is cured by light irradiation, is but the curing may be accelerated by heating in addition to the light irradiation. Furthermore, in place of the light curable-type resin agent RA, the resin layers 94 and 694 etc. can also be formed from a resin that is curable by different energy such as a heat curable-type resin.

In the above-mentioned embodiments, by the positioning device 50, the gap between the rear surface 91b of the molding die 91 and the rear surface 95b of the transparent substrate 95 or the like is adjusted, but gaps other than these can also be adjusted. The positioning device 50 is provided independently of the molding die 91, the transparent substrate 95 or the like, to thereby enable gap adjustment free from limitations of surface shapes of the molding die 91 and the transparent substrate 95.

In the above-mentioned embodiment, the abutment device 51 is provided around the molding die 91 and the transparent substrate 95, but when a through-hole is provided in the molding die 91 and the transparent substrate 95, the abutment device 51 can also be arranged inside the molding die 91 and the transparent substrate 95. In this case, the reliability and stability of the gap adjustment can be enhanced.

The structure of the abutment device 51 shown in FIG. 3 and the like is a mere exemplification, and various mechanisms can be used when they can stably move up and down the rod part 52 with a high degree of accuracy.

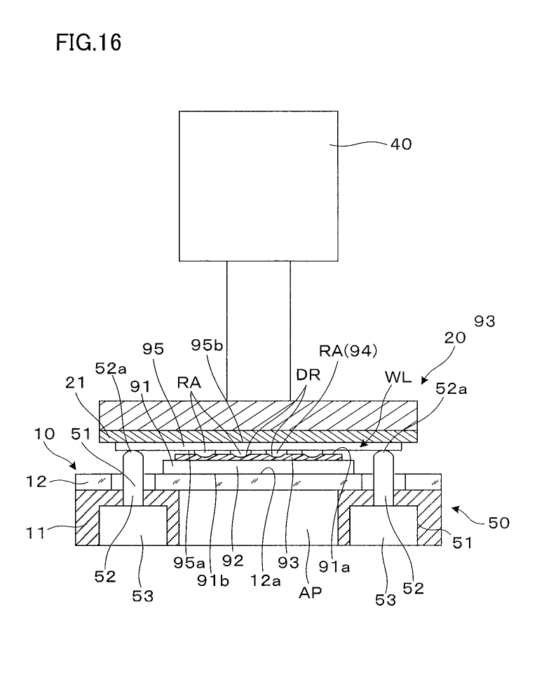

Meanwhile, when the variation in thickness of the transparent substrate 95 is as small as it does not cause troubles, an object to which the rod part 52 of the abutment device 51 is to be abutted is not limited to surfaces of the back plates 12 and 21, but various reference positions can be set. For example, as shown in FIG. 16, by providing a part that is a non-transfer surface on a periphery of the front side surface 95a of the transparent substrate 95 and abutting the end part 52a of the rod part 52 to the non-transfer surface part, only by defining precisely the thickness from the surface of the optical surface to be molded to the surface of the transparent substrate 95, it becomes possible to obtain a wafer lens in which optical elements having uniform optical specifications are formed.

1. A method for producing a wafer lens, the method forming a resin layer having a plurality of optical surfaces on at least one surface of a flat plate-shaped substrate having light transmittivity, by transfer using a molding die, wherein:
when molding the plurality of optical surfaces on the substrate by the molding die,
a gap between the molding die supported by a die support member and the substrate supported by a substrate support member is adjusted using a positioning device which is provided, independently of the molding die, on at least one side of a substrate support member side and a die support member side, and which has an abutment member abutting to the other side of the substrate support member side and the die support member side when the substrate support member and the die support member come close to each other.

2. The method for producing a wafer lens according to claim 1,
wherein a gap between the molding die and the substrate which is made by the positioning device is corrected on the basis of a dimensional error of the wafer lens formed at a previous time.

3. The method for producing a wafer lens according to claim 1, wherein
the positioning device is provided on both of the die support member side and the substrate support member side and has a first abutment member provided on the die support member side and a second abutment member provided on the substrate support member side, and
the positioning device adjusts the gap between the molding die and the substrate by changing a projection amount of at least one of the first abutment member and the second abutment member.

4. A device for producing a wafer lens, comprising:
a substrate support member supporting a flat plate-shaped substrate having light transmittivity;
a die support member which is arranged facing the substrate and which supports a molding die for molding, by transfer, a resin layer having a plurality of optical surfaces on one surface of the substrate;
a lifting device causing the substrate support member and the die support member to come close to and separate from each other; and
a positioning device which is provided, independently of the molding die, on at least one side of a substrate support member side and a die support member side and which has an abutment member adjusting the gap between the molding die and the substrate by being abutted to the other side of the substrate support member side and the die support member side when the substrate support member and the die support member are caused to come close to each other by the lifting device.

5. The device for producing a wafer lens according to claim 4,
wherein the positioning device is provided on the die support member side, and the abutment member is abutted to a predetermined surface that serves as a basis of arrangement of the substrate.

6. The device for producing a wafer lens according to claim 5, wherein the abutment member is abutted to a surface of a back plate supporting the substrate from behind.

7. The device for producing a wafer lens according to claim 4,
wherein the positioning device is provided on the substrate support member side, and the abutment member is abutted to a predetermined surface while avoiding a resin layer constituting the molding die.

8. The device for producing a wafer lens according to any one of claim 4,
wherein the positioning device is arranged in three positions around of the substrate and the molding die, and makes projection amounts of the abutment members of the positioning device changeable individually.

9. The device for producing a wafer lens according to claim 4,
wherein the positioning device is provided on both of the die support member side and the substrate support member side and has a first abutment member provided on the die support member side and a second abutment member provided on the substrate support member side, to abut the first abutment member and the second abutment member to each other.

10. The device for producing a wafer lens according to claim 9,
wherein the positioning device changes a projection amount of at least one of the first abutment member and the second abutment member, and thus, changes the gap between the molding die and the substrate.

11. A method for producing an optical element obtaining the optical element by cutting, into pieces, a wafer lens produced by the method for producing a wafer lens according to claim 1.

12. A method for producing an optical element obtaining the optical element by cutting, into pieces, a wafer lens produced by the device for producing a wafer lens according to claim 4.
